(19) United States
(12) Patent Application Publication
(10) Pub. No.: US 2022/0035029 A1
(43) Pub. Date: Feb. 3, 2022

(54) METHOD FOR EVALUATING AN EFFECT OF AN OBJECT IN THE SURROUNDINGS OF A TRANSPORT DEVICE ON A DRIVING MANEUVER OF THE TRANSPORT DEVICE

(71) Applicant: Robert Bosch GmbH, Stuttgart (DE)

(72) Inventors: Jianda Wang, Yokohama-Shi (JP); Juergen Schmidt, Magstadt (DE); Tom Reimann, Bissingen An Der Teck (DE); Werner Urban, Vaihingen/Enz (DE)

(73) Assignees: Robert Bosch GmbH, Stuttgart (DE); Robert Bosch GmbH, Stuttgart (DE)

(21) Appl. No.: 17/278,468

(22) PCT Filed: Sep. 20, 2019
(86) PCT No.: PCT/EP2019/075428

§ 371 Date: Mar. 22, 2021

(30) Foreign Application Priority Data
Sep. 28, 2018 (DE) 102018216790.7

(51) Int. Cl. G01S 15/931; G01S 7/54; G01S 15/87

(52) U.S. Cl. CPC G01S 15/931; G01S 2015/937; G01S 15/876; G01S 7/54

(57) ABSTRACT

A method for evaluating an effect of an object in the surroundings of a transport device on a driving maneuver of the transport device. The method includes: ascertaining a first distance between the object and a first position of the transport device with the aid of a first ultrasonic sensor of the transport device; ascertaining a second distance between the object and a second position of the transport device different from the first position, using the first ultrasonic sensor of the transport device; calculating a change between the first distance and the second distance with regard to a path, which corresponds to a distance traveled between the first position and the second position of the transport device; and taking into account or not taking into account the object during the execution of the driving maneuver of the transport device as a function of a result of the calculation.

### FIELD

The present invention relates to a method and a device for evaluating an effect of an object in the surroundings of a transport device on a driving maneuver of the transport device; and, in particular, to an evaluation of an ability of the object to be driven under by the transport device.

### BACKGROUND INFORMATION

Certain parking and maneuvering assistance systems for transport devices, which utilize, inter alia, ultrasonic signals to monitor the surroundings of the transport device, are conventional. One reason for using ultrasonic signals is the high measuring accuracy in the short and/or ultra-short range associated with this technology. With the intention of more effective range coverage during the monitoring of the surroundings of the transport devices, a plurality of ultrasonic sensors are used, generally, in combination. In order to close, as completely as possible, blind spots, e.g., in the region of a bumper of the transport device, which are possibly present during the monitoring, a minimal detection range and a beam angle, as well as a sensitivity of the ultrasonic sensors, have been further improved in a continuous manner. Thus, modern ultrasonic sensors may cover a detection range of 10 cm to 7 m, while at the same time, detection angles of up to 85° are attained for large objects in the surroundings of the transport device. Based on the high sensitivity of modern ultrasonic sensors, objects in the surroundings of the transport device, such as overhead signs, top edges of garages, or ceiling girders in an underground parking garage, which are not critical and/or not relevant to a driving maneuver of the transport device, are often detected, as well, which means that a suitable method for recognizing and suppressing them becomes necessary.

German Patent Application No. DE 102016213377 A1 describes a method and a device for determining a drive-through height of a narrow vertical spot to be driven under by a vehicle, on the basis of a monocular camera; prominent features of the vehicle surroundings being identified in the sequence of images recorded by the camera. In addition, a virtual 3-d image of the vehicle surroundings is generated from the identified features in relation to a vehicle coordinate system, in that its displacement in the image sequence allows a deduction of its specific position.

German Patent Application No. DE 102011113077A1 describes a method and a device for determining, with the aid of a 3-d camera, an ability of an object to be driven through by a vehicle; corresponding information for the determination being ascertained from image data of the 3-d camera. Furthermore, a dimension and shape of a surface or a space, which is intended to be driven through, may be ascertained, in particular, in view of the motion of the 3-d camera, on the basis of the motion of the vehicle. To this end, a 3-d scene reconstruction may advantageously be carried out from the image data of the 3-d camera, for example, using the method of optical flow.

German Patent Application No. DE 102012211034A1 describes a driver assistance system for ascertaining a distance from a vehicle to an obstacle above a vehicle, in order to calculate a pass-through height beneath the obstacle; the distance being able to be ascertained with the aid of an ultrasonic sensor, which is preferably positioned on the vehicle in such a manner, that the measurement of distance in the vertical direction is carried out. The distance-measuring with the aid of the sensor takes place on the basis of the sonar method, by evaluating the transit time of the ultrasonic pulse to the obstacle and of the echo pulse reflected back to the sensor by the obstacle. This allows the distance to the obstacle to be determined, since the position of the sensor on the vehicle is known.

### SUMMARY

According to a first aspect, the present invention provides a method for evaluating an effect of an object in the surroundings of a transport device on a driving maneuver of the transport device, and, in particular, an evaluation of an ability of the object to be driven under by the transport device. The transport device may be, for example, a road vehicle (e.g., shuttle, bus, motorcycle, e-bike, passenger car, van, cargo truck) or a watercraft. In accordance with an example embodiment of the present invention, in a first step of the method according to the present invention, a first distance between the object and a first position of the transport device or, more precisely, a position of the first ultrasonic sensor at the first position of the transport device, is ascertained with the aid of a first ultrasonic sensor of the transport device; the first distance being able to be measured on the basis of direct echoes of the ultrasonic signals emitted by the first ultrasonic sensor. In this connection, the first ultrasonic sensor and also further ultrasonic sensors used for the method of the present invention may be, in particular, highly sensitive ultrasonic sensors and, preferably, ultrasonic sensors having a detection range of 10 cm to 7 m and a detection angle of up to 85°. It is emphasized that these specifications are not limiting, and that instead, ultrasonic sensors having both greater detection ranges and detection angles and smaller detection ranges and detection angles may be used. In addition, the first ultrasonic sensor and, in some instances, additional, utilized ultrasonic sensors may preferably be part of a current driver assistance system of the transport device and may be situated at desired, suitable positions on the transport device. The first ultrasonic sensor and further ultrasonic sensors may preferably be positioned mainly in the front part of the transport device and/or in the rear part of the transport device, so that in the case of traveling forwards or backwards, the surroundings of the transport device may be monitored by the ultrasonic sensors in a suitable manner. Of course, this does not rule out that, alternatively or additionally, ultrasonic sensors may be situated at other positions of the transport device, such as on the sides of the transport device.

The first distance may be ascertained and the method steps described in the following may be executed on the basis of an evaluation unit of the present invention, which is configured to receive signals of the first ultrasonic sensor and, possibly, of further ultrasonic sensors with the aid of a data input. The evaluation unit may take the form of, for example, a processor, digital signal processor, microcontroller, or the like. A logic circuit for executing the specific method steps of the present invention may be implemented, for example, in the form of a computer program, which may be executed by the evaluation unit. The evaluation unit may preferably include an internal and/or external storage unit connected to the evaluation unit so as to be able to exchange information, in order, for example, to store data generated and/or received by the evaluation unit. In addition, the evaluation unit and/or the computer program executed by the evaluation unit may be part of a current driver assistance system or of another control unit of the transport device.

A value of the first distance ascertained by the ultrasonic sensor may be stored in the storage unit with the aid of the evaluation unit. Furthermore, an information item regarding the first position of the transport device, at which the first distance is measured, may be stored in the storage unit, as well. This information may be received, for example, by the evaluation unit from an odometric control unit of the transport device, via the vehicle electrical system of the transport device. The odometric control unit may calculate relative positional changes, for example, on the basis of an evaluation of rotations of one or more wheels of the transport device, in combination with an evaluation of respective steering angles of the wheel(s) of the transport device. Alternatively, or in addition, the first position may also be determined on the basis of a GPS system of the transport device, or on the basis of further position-determining methods (such as WLAN position-finding, etc.).

In a second step of the method according to an example embodiment of the present invention, a second distance between the object and a second position of the transport device different from the first position is ascertained with the aid of the first ultrasonic sensor. The determination of the second distance and the second position may preferably be carried out in a manner analogous to the determination of the first distance and the first position. An ascertained value of the second distance and an information item regarding the second position may be stored, in turn, in the storage unit.

In a third step of the method of an example embodiment of the present invention, a change between the first distance and the second distance is calculated with regard to a path, which corresponds to a distance traveled between the first position and the second position of the transport device. For the case, in which the first position and the second position are ascertained on the basis of odometric data, the distance traveled between the two positions may be calculated by subtracting the respective values of the first position and the second position. A change in the first distance and the second distance with regard to the distance traveled may be expressed and calculated by the following formula: D2d=(d1−d2)/s; D2d standing for “Distance to Drive Distance Coefficient” and representing a quotient of the present invention for evaluating an ability of an object to be traveled under or passed through by the transport device; d1 and d2 representing the first distance and the second distance, respectively; and s representing the distance traveled between the first position and the second position. For the case, in which the object to be evaluated with regard to an ability to be driven under and/or passed through is situated more or less precisely in the region of the main transmission axis and/or main receiving axis of the first ultrasonic sensor (also referred to below as the sensor axis), in front of the ultrasonic sensor and/or the transport device, a value of the change between the first distance and the second distance (d1−d2) corresponds to a value of the distance traveled. Thus, the quotient of these values yields a value of 1 and therefore represents a maximum collision risk with an object located at the elevation of the transport device. The further away the object is from the sensor axis, the lower a value of a change between the first distance and the second distance becomes with regard to the distance traveled between the two measurements of the first distance and the second distance. That is, the further away the object lies from the sensor axis in the horizontal and/or vertical direction, the smaller the quotient D2d becomes, and the lower a collision risk of the transport device with the object may be classified.

In a fourth step of the method according to an example embodiment of the present invention, the object is taken into account or not taken into account as a function of a result of the above-described calculation in the third method step during the execution of the driving maneuver of the transport device. The driving maneuver may be, for example, a parking event in a parking garage; objects not relevant to a collision, such as a ceiling girder detected by the first ultrasonic sensor, preferably not being intended to result in the output of a warning signal (e.g., an acoustic warning over a sound system of the transport device and/or an optical warning in a display of the transport device).

A collision relevance may be evaluated by the evaluation unit of the present invention, in that the D2d value previously ascertained for a specific, detected object in the surroundings of the transport device is compared to a predefined threshold value, which may be stored in the storage unit. This predefined threshold value may preferably be a vehicle-specific threshold value, which may be ascertained in view of a maximum dimension of the transport device (height, width and, possibly, length, as well) and a configuration and orientation of the first ultrasonic sensor with regard to the transport device. The threshold value is preferably set in view of a predefined distance between the first position and the second position, so that all of the reference variables for ascertaining a collision relevance of a specific object have been fixed. This means that the first distance and the second distance from the specific object may preferably be measured in view of the predefined distance between the first position and the second position.

An evaluation of a collision relevance of a specific object carried out in this manner may be transmitted by the evaluation unit of the present invention to a parking and/or maneuvering assistance system in the form of a collision information item, which means that this object may be taken into account or not taken into account by the driving assistance system as a function of the evaluation. Alternatively, or in addition, the collision information item may also be transmitted to a control unit for semiautomatic or fully automatic operation of the transport device, so that this control unit may adapt a driving maneuver to be performed currently to the collision information item in a suitable manner.

The method described above assumes that between a first distance measurement at the first position and a second distance measurement at the second position, an object in the surroundings of the transport device detected by the first ultrasonic sensor may be identified as one and the same object, so that the specific, measured distances may be related to each other. For this purpose, numerous methods for object identification and/or object detection and object localization, which may be used in this context and are, accordingly, not explained here in further detail, are known from the related art.

Preferred further refinements and example embodiments of the present invention are disclosed herein.

In one further advantageous refinement of the present invention, a horizontal position of the object with regard to a trajectory of the transport device is ascertained on the basis of at least one second ultrasonic sensor and an object localization algorithm. For example, the second ultrasonic sensor may be situated next to the first ultrasonic sensor in the horizontal direction, in the front-end region of the transport device. The substantially parallel orientation of the first and second ultrasonic sensors in the direction of travel of the transport device may allow objects potentially relevant to a collision to be detected, generally, by both the first ultrasonic sensor and the second ultrasonic sensor. In addition, the second ultrasonic sensor may preferably be connected to the evaluation unit of the present invention analogously to the first ultrasonic sensor, in a manner allowing for the exchange of information. This means that in the course of monitoring the surroundings at a specific position of the transport device, the evaluation unit may receive measuring signals of the first ultrasonic sensor and of the second ultrasonic sensor. In the ideal case, the evaluation unit may unequivocally identify one and the same object in the measuring signals of the first ultrasonic sensor and in the measuring signals of the second ultrasonic sensor, with the aid of a suitable algorithm. Since a distance between the first ultrasonic sensor and the second ultrasonic sensor is also known to the evaluation unit (e.g., using values stored in the storage unit for the configuration and orientation of the ultrasonic sensors on the transport device), it may ascertain a horizontal position and a distance of the specific object with regard to the trajectory of the transport device, by subsequently using a suitable object localization algorithm, which may be, for example, a lateration algorithm. On the basis of the ascertained information about a horizontal position of a specific object, an ability of the specific object to be passed on the side may be evaluated, and an information item about a collision relevance derived from it may be used in a manner analogous to method steps described above. Remaining objects, that is, objects, which are potentially relevant to a collision on the basis of a current trajectory of the transport device, and due to their horizontal position, may subsequently be evaluated with regard to an ability to be driven under, with the aid of the method steps according to the present invention.

It is emphasized that all of the method steps described above are not limited to the use of a first and/or second ultrasonic sensor, but that further ultrasonic sensors (for example, third, fourth, or more) may also be used, in order to improve, inter alia, object localization and/or to ensure a greater detection range due to a plurality of ultrasonic sensors.

It is also pointed out that the evaluation of the ability of an object to be driven under and/or passed by the transport device preferably takes place on the basis of the measuring signals of the first ultrasonic sensor and the second ultrasonic sensor used for determining the horizontal position; the measuring signals being able to be stored temporarily in the storage unit for subsequent evaluation of the ability to be driven under and/or passed, and being able to be correspondingly retrieved from there. In this manner, remeasurement of the first distance and the second distance at the first and second positions is not necessary.

In a further advantageous refinement of the present invention, the change between the first distance and the second distance with regard to the distance traveled is calculated as a function of the first distance's and/or the second distance's falling below a predefined distance. In other words, calculation of the D2d value by the evaluation unit of the present invention for a specific object may be omitted, if an ascertained first and/or second distance is greater than the predefined distance. The predefined distance may be stored in the storage unit, as well, and may correspond to a value, which represents, for example, a distance of 6 m or 7 m. In addition, the predefined distance may be adapted as a function of a current speed of the transport device. In this manner, objects located further away relative to the transport device may be classified by the evaluation unit as not relevant to a collision, as long as they are further away than the predefined distance.

In one further advantageous refinement of the present invention, while covering the distance between the first position and the second position, the transport device moves towards the object while substantially maintaining a current direction of travel. In this manner, objects identified in the surroundings of the transport device may be evaluated more reliably with regard to an ability to be driven under and/or passed, since the approach of the transport device takes place in a predefined manner. Frequent changes of direction of the transport device may make identification of one and the same object in the measuring signals of the first distance measurement and of the second distance measurement more difficult, since a viewing angle towards the object and a position of the transport device with regard to the object correspondingly changes between the specific measurements. Particularly for the case, in which the method of the present invention is used in connection with a transport device traveling autonomously, the control unit for the autonomous driving may preferably be adapted in such a manner, that, if possible, the transport device approaches objects potentially relevant to a collision with a trajectory of the transport device that runs substantially in a straight line.

In a further advantageous refinement of the present invention, the result of the calculation includes an information item regarding an ability of the object to be driven under or passed in view of a position of the object relative to a trajectory and of dimensions of the transport device. This information item may be transmitted by the evaluation unit to the parking and/or maneuvering assistance system, so that the parking and/or maneuvering assistance system may output appropriate warnings of objects relevant to a collision in the transport device and/or propose and/or control an adapted trajectory for the transport device. An evaluation of an ability of an object to be passed may also include the case, in which an object is situated directly on the surface of a roadway driven on by the transport device and, due to a low height (e.g., a curb), may be driven over by the transport device. Such an information item may be ascertained, as well, on the basis of the method of the present invention and transmitted to a driver assistance system.

In addition, the method of the present invention may be supported by the use of additional and/or alternative sensors, which are for monitoring the surroundings, and whose acquired surrounding-area information may have an influence on the evaluation of an ability of an object to be driven under and/or passed by the transport device. Inter alia, lidar and radar sensors, cameras, and other types of sensors, as well, are considered in this context.

In one further advantageous refinement of the present invention, in connection with the method according to the present invention, an information item regarding changed dimensions of the transport device is taken into account. In other words, a predefined information item, which is adapted to a specific transport device, is in regard to a maximum height, width and length, and is preferably stored in the storage unit, may be adjusted to changed dimensions of the respective transport device, for example, by user input. This may then be advantageous, in particular, if, for example, a height of the transport device changes through use of a roof rack, or a width, a height and a length of the transport device changes due to use of a trailer (e.g., a camper) with the transport device. In response to the input of such modified values of the dimensions of the transport device by a user, the evaluation unit may ascertain an adapted, predefined threshold value for the evaluation of an ability to be driven under and/or passed. Alternatively, or in addition, the storage unit may also include a table, which supplies predefined threshold values corresponding to a plurality of height, width and length combinations of the dimensions of the transport device.

According to a second aspect of the present invention, a device is provided for evaluating an effect of an object in the surroundings of a transport device on a driving maneuver of the transport device. The device includes an evaluation unit having a data input and a data output. The evaluation unit may take the form of, for example, a processor, digital signal processor, microcontroller, or the like. Logic for executing the specific method steps of the present invention may be implemented, for example, in the form of a computer program, which is executed by the evaluation unit. The evaluation unit may preferably include an internal and/or external storage unit connected to the evaluation unit so as to be able to exchange information, in order, for example, to store data generated and/or received by the evaluation unit. In addition, the evaluation unit and/or the computer program executed by the evaluation unit may be part of a current driver assistance system or of another control unit of the transport device. Furthermore, in conjunction with the data input, the evaluation unit is configured to ascertain a first distance between the object and a first position of the transport device with the aid of a first ultrasonic sensor, and to ascertain a second distance between the object and a second position of the transport device different from the first position, with the aid of the first ultrasonic sensor of the transport device. Moreover, the evaluation unit is configured to calculate a change between the first distance and the second distance with regard to a stretch of path, which corresponds to a distance traveled between the first position and the second position of the transport device. In conjunction with the data output, the evaluation unit is additionally configured to take into account or not to take into account the object during the execution of the driving maneuver of the transport device, as a function of the result of the calculation.

### BRIEF DESCRIPTION OF THE DRAWINGS

Below, exemplary embodiments of the present invention are described in detail with reference to the figures.

FIG. 1 shows a flow chart illustrating steps of an exemplary embodiment of a method according to the present invention.

FIG. 2 shows an example for ascertaining an ability of an object to be driven under by a transport device, in accordance with an example embodiment of the present invention.

FIG. 3 shows a block diagram of a device according to an example embodiment of the present invention, together with a transport device.

### DETAILED DESCRIPTION OF EXAMPLE EMBODIMENTS

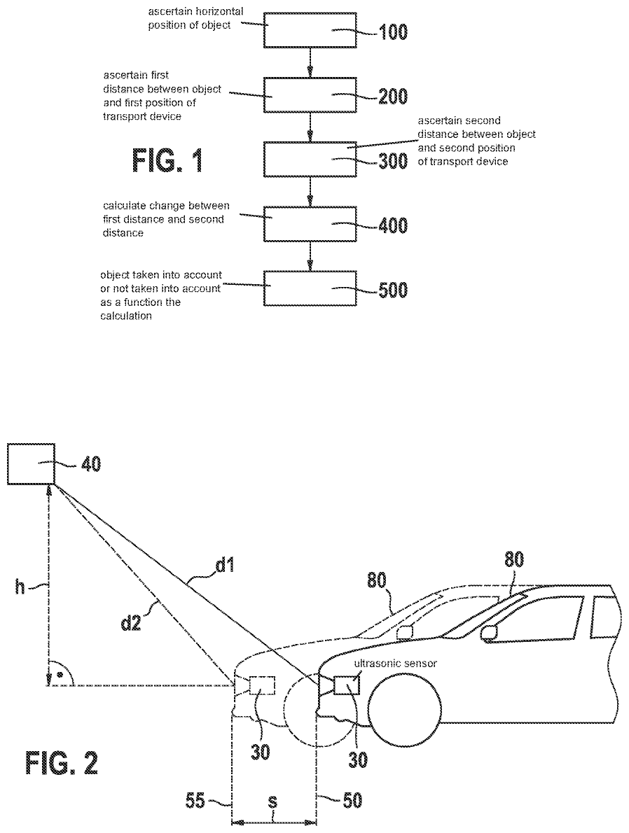

FIG. 1 shows a flow chart illustrating steps of an exemplary embodiment of a method according to the present invention. In step 100, a horizontal position of an object 40 relative to a current trajectory of transport device 80 is ascertained with the aid of a first ultrasonic sensor 30 and a second ultrasonic sensor 35, in conjunction with an object localization algorithm. The ascertainment takes place on the basis of an evaluation unit 10 of the present invention, which, in this exemplary embodiment, is a microcontroller. In step 200, a first distance d1 between object 40 and a first position 50 of transport device 80 is ascertained on the basis of the measuring signals, which are generated by first ultrasonic sensor 30 and are for the determination of the horizontal position of object 40. In step 300, a second distance d2 between object 40 and a second position 55 of transport device 80 is ascertained in an analogous manner. In step 400, a change between first distance d1 and second distance d2 with regard to a path s is calculated, which corresponds to a distance traveled s between first position 50 and second position 55 of transport device 80. Distance traveled s is calculated on the basis of a signal of an odometric control unit of transport device 80 received by evaluation unit 10. In step 500, object 40 is taken into account or not taken into account during the execution of a current driving maneuver of transport device 80 as a function of a result of the calculation. For the case, in which object 40 is potentially relevant to a collision for transport device 80, a corresponding information item regarding object 40 is transmitted to a parking and maneuvering assistance system of transport device 80.

FIG. 2 shows an example for ascertaining an ability of an object 40 to be driven under by a transport device 80; the object 40 being situated at an elevation h relative to a first ultrasonic sensor 30 of transport device 80, which allows object 40 to be driven under by transport device 80. First ultrasonic sensor 30, which is positioned on a bumper of transport device 80 in the direction of travel of transport device 80, takes the form of a highly sensitive ultrasonic sensor having a detection range of 10 cm to 7 m and a detection angle of up to 85°. In addition, transport device 80 includes an evaluation unit 10, which is connected to first ultrasonic sensor 30 via a data input 12 so as to be able to exchange information. Due to the relatively high sensitivity, and due to the relatively large detection angle of first ultrasonic sensor 30, objects 40, which are not critical and/or not relevant with regard to an ability to be driven under and/or passed by transport device 80, are also detected by first ultrasonic sensor 30 in the surroundings of transport device 80. For this reason, with the aid of evaluation unit 10, an algorithm of the present invention, which is able to ascertain these uncritical and/or irrelevant objects 40, is executed by evaluation unit 10 in the form of a computer program, in order not to consider them in subsequent processing by a driver assistance system 90 coupled to evaluation unit 10. In this manner, driver assistance system 90 is prevented from outputting unnecessary warnings and/or instructions to a driver of transport device 80 and/or from unnecessarily adjusting the operation (e.g., braking or changing the direction of travel) of transport device 80 automatically, on the basis of these irrelevant objects 40.

For this purpose, a first value, which represents a measured, first distance d1 between object 40 and a sensor surface of first ultrasonic sensor 30, is received from first ultrasonic sensor 30 by evaluation unit 10 of the present invention, at a first position 50 of the moving transport device 80. With the aid of evaluation unit 10, the first value is stored in an external storage unit 20 connected to the evaluation unit. After transport device 80 has traveled a predefined distance s (e.g., 50 cm), then, in a manner analogous to the measurement of the distance of object 40, a measurement of the distance between object 40 and transport device 80 is carried out once more at a second position 55 of transport device 80, using first ultrasonic sensor 30. A second value of a second distance d2 between object 40 and transport device 80, which is ascertained in this manner and received by evaluation unit 10, is stored in storage unit 20, as well. In addition, evaluation unit 10 is connected by a vehicle electrical system of transport device 80 to an odometric control unit, which provides evaluation unit 10 information regarding a distance traveled s by transport device 80. In this manner, evaluation unit 10 is able to ascertain a value regarding the distance traveled s between first position 50 and second position 55, in order to store it in storage unit 20, as well. A change of first distance d1 and second distance d2 in the form of a value d is subsequently calculated by evaluation unit 10: d=d1−d2. A ratio of this value to distance traveled s is formed to calculate a quotient of the present invention D2d (“Distance to Drive Distance Coefficient”): D2d=d/s. Quotient D2d is compared by evaluation unit 10 to a predefined threshold value, which represents a vehicle-specific value of an ability to be driven under by transport device 80; the value being stored in storage unit 20. For the case in which the D2d value is less than or equal to the predefined threshold value, an ability of object 40 to be driven under may be assumed accordingly. Due to the ability of object 40 to be driven under, it is not transmitted to driver assistance system 90 for further processing and, consequently, not used for current vehicle operation and/or a current driving maneuver of transport device 80.

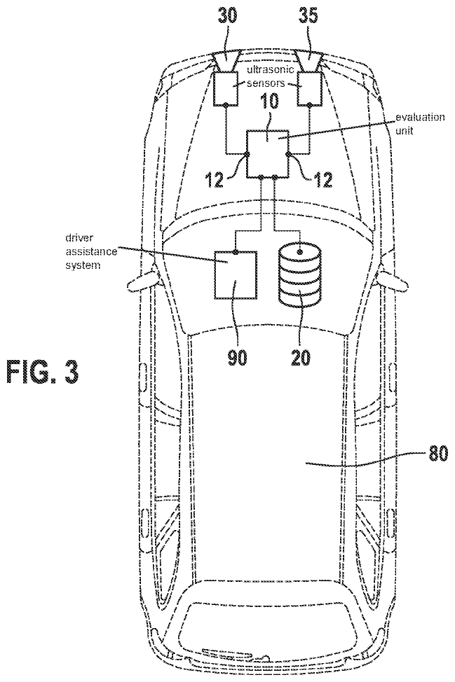

FIG. 3 shows a block diagram of a device of the present invention, together with a transport device 80. The device includes an evaluation unit 10, which is, in this example, a microcontroller. A computer program, which is able to carry out the method steps of the present invention, is executed by the microcontroller. Evaluation unit 10 has a data input 12, via which evaluation unit 10 is connected to a first ultrasonic sensor 30 and a second ultrasonic sensor 35 so as to be able to exchange information. In this manner, evaluation unit 10 is configured to receive and to process signals representing the surroundings of a transport device 80. The received signals and/or calculation results and, possibly, other data, are stored in an external storage unit 20, which is connected to evaluation unit 10 so as to be able to exchange information. In addition, evaluation unit 10 has a data output 14, via which evaluation unit 10 is connected to a driver assistance system 90 of transport device 80 so as to be able to exchange information. Evaluation unit 10 is configured to evaluate abilities of objects 40 in the surroundings of transport device 80 to be driven under, and to transmit only data about objects 40 relevant to a collision to driver assistance system 90.

1-10. (canceled)

11. A method for evaluating an effect of an object in surroundings of a transport device on a driving maneuver of the transport device, comprising the following steps:
ascertaining a first distance between the object and a first position of the transport device using a first ultrasonic sensor of the transport device;
ascertaining a second distance between the object and a second position of the transport device different from the first position, using the first ultrasonic sensor of the transport device;
calculating a change between the first distance and the second distance with regard to a path, which corresponds to a distance traveled between the first position and the second position of the transport device; and
taking into account to object or not taking into account the object during execution of the driving maneuver of the transport device as a function of a result of the calculation.

12. The method as recited in claim 11, further comprising:
ascertaining a horizontal position of the object relative to a trajectory of the transport device based on at least one second ultrasonic sensor and an object localization algorithm.

13. The method as recited in claim 11, wherein the first distance and the second distance are each ascertained between the object and a sensor surface of the first ultrasonic sensor on the transport device.

14. The method as recited in claim 11, wherein the object is taken into account or not taken into account based on a comparison of the result of the calculation to a predefined threshold value.

15. The method as recited in claim 11, wherein the first distance and the second distance are ascertained additionally based on at least a second ultrasonic sensor.

16. The method as recited in claim 11, wherein the change between the first distance and the second distance with regard to the distance traveled is calculated as a function of the first distance and/or the second distance falling below a predefined distance.

17. The method as recited in claim 11, wherein while covering the distance between the first position and the second position, the transport device moves towards the object while substantially maintaining a current direction of travel.

18. The method as recited in claim 11, wherein the result of the calculation includes an information item regarding an ability of the object to be driven under and/or passed on a side, in view of a position of the object relative to a trajectory and of dimensions of the transport device.

19. The method as recited in claim 18, wherein an information item regarding changed dimensions of the transport device is taken into account.

20. A device for evaluating an effect of an object in surroundings of a transport device on a driving maneuver of the transport device, comprising:
an evaluation unit;
a data input; and
a data output;
wherein the evaluation unit is configured to:
in connection with the data input:
ascertain a first distance between the object and a first position of the transport device using a first ultrasonic sensor of the transport device, and
ascertain a second distance between the object and a second position of the transport device different from the first position, using
the first ultrasonic sensor of the transport device;
calculate a change between the first distance and the second distance with regard to a path, which corresponds to a distance traveled between the first position and the second position of the transport device; and
in conjunction with the data output, take into account the object or not take into account the object during execution of the driving maneuver of the transport device as a function of a result of the calculation.
